(19) United States
(12) Patent Application Publication
(10) Pub. No.: US 2019/0145269 A1
(43) Pub. Date: May 16, 2019

(54) CERAMIC COMPONENT FOR COMBUSTION TURBINE ENGINES

(71) Applicant: Siemens Aktiengesellschaft, München (DE)

(72) Inventor: Christian Xavier Campbell, West Hartford, CT (US)

(21) Appl. No.: 16/097,963

(22) PCT Filed: May 10, 2016
(86) PCT No.: PCT/US2016/031605

§ 371 Date: Oct. 31, 2018

(51) Int. Cl. F01D 5/28; F01D 5/14; F01D 9/04

(52) U.S. Cl. CPC F01D 5/284; F01D 5/282; F01D 5/147; F01D 9/041; F05D 2300/6033; F05D 2250/11; F05D 2240/301; F05D 2230/31; F05D 2250/184; F05D 2250/12; F05D 2240/126

(57) ABSTRACT

A component for a combustion turbine engine has a ceramic matrix composite (“CMC”) central substrate with a substrate rib that bridges opposed substrate sidewalls. The central substrate includes an embedded first pattern of reinforcing fibers, which is laid-up from a pair of fabric reinforcement sheets. The respective sheets include a spine with coplanar, flanking strips. Alternate rows of strips on each sheet are folded into projecting pleats. The respective sheets are oriented with their spines in opposed and mutually spaced relationship. Spines of the respective sheets are embedded within their respective substrate sidewalls. Pleat rows of the respective sheets are embedded within the substrate rib and its opposing respective first or second sidewall.

### TECHNICAL FIELD

The invention relates to ceramic matrix composite (“CMC”) components for combustion or gas turbine engines, such as turbine blades, vanes, combustion transitions, or engine casing liners. More particularly, the invention relates to CMC components, which incorporate fiber-reinforced, solidified ceramic substrates, for structural support of the components. The fiber reinforcement in each substrate is constructed from reinforcement fabric sheets that are folded into structures, prior to embedding within cured, solidified ceramic material.

### BACKGROUND

Known combustion or gas turbine engines include: a multi-stage compressor section, a combustion section, a multi-stage turbine section, and a rotor. A plurality of combustors is coupled to a downstream transition component that directs combustion gasses from the combustor to the turbine section. Atmospheric pressure intake air is drawn into the compressor section generally in a direction of the flow along the axial length of the turbine engine. The intake air is progressively pressurized in the compressor section by rows rotating compressor blades, and directed by mating compressor vanes to the combustion section, where it is mixed with fuel and ignited. The ignited high-temperature fuel/air mixture, now under greater pressure and velocity than the original intake air, is directed through the transition to the sequential vane and blade rows in the turbine section. The engine's rotor and shaft retain the plurality of rows of airfoil cross sectional shaped turbine blades. Traditionally, components with combustion turbine engines that are exposed to hot combustion gasses, such as combustor baskets, combustor transitions, engine casing liners, turbine section blades and turbine section vanes, are constructed of nickel or cobalt based superalloys.

An exemplary, known type of cast-metal turbine blade 20, constructed from superalloy material, is shown in FIG. 1. The blade 20 has a blade root and platform 22, from which axially projects a blade airfoil 24 that terminates in a squealer-type blade tip 26. The blade airfoil 24 has a pressure side 28 and a lower-pressure, suction side 30. An integrally cast reinforcing rib 32 bridges the hollow blade airfoil 24, delimiting the hollow blade cavity into a forward blade cavity 34 and an aft blade cavity 36. The underlying nickel or cobalt based superalloy substrates are generally limited to approximately 950 to 1000 degrees Celsius operating temperatures. Combustion temperatures above 1000 degrees Celsius are desirable, for increased engine operating efficiency. To this end, blade fluid cooling features have been incorporated into blades, in order to allow their operation at higher combustion temperatures. An external insulation layer, or thermal barrier coating (“TBC”) 38 is typically applied over the superalloy substrates located in the first few turbine stages, enabling engine-operating temperatures greater than 1400 degrees Celsius, while limiting the superalloy substrate internal temperature to 1000 degrees Celsius or less.

Ceramic matrix composite (“CMC”) structures are being incorporated into gas turbine engine components as insulation layers and/or structural elements of such components, such as insulating sleeves, vanes and turbine blades, replacing their predecessor-type, superalloy metal components. The CMCs comprise structural support fibers embedded within a cured, solidified ceramic material. The embedded fibers within the ceramic substrate of the CMC improve elongation rupture resistance, fracture toughness, thermal shock resistance, and dynamic load capabilities, compared to ceramic structures that do not incorporate the embedded fibers. The CMC embedded fiber orientation also facilitates selective anisotropic alteration of the component's structural properties. CMC structures are fabricated by orienting ceramic fibers, also known as “rovings”, into fabrics, filament windings, multiple-strand tows, or braids. Fiber-reinforcement fabrication for CMCs is comparable to what is done to form fiber-reinforced polymer structural components for aircraft wings or boat hulls. The fibers are pre-impregnated with ceramic material prior to their orientation, or alternatively, subsequent to orientation they are then impregnated with ceramic material by such techniques as gas deposition, melt infiltration, preceramic polymer pyrolysis, chemical reactions, sintering, or electrophoretic deposition of ceramic powders, creating a solid ceramic structure with embedded, oriented ceramic fibers.

CMC components in combustion turbine engines provide better oxidation resistance, and higher temperature capability, in the range of approximately 1150 degrees Celsius (“C”) for oxide based ceramic matrix composites, and up to around 1350 C for Silicon Carbide fiber-Silicon Carbide substrate (“SiC-SiC”) based ceramic matrix composites, which is significantly higher than the 1000 degrees Celsius temperature limit of superalloy materials components that are subjected to similar operating conditions within engines. While 1150 C (1350 C for SiC-SiC based CMCs) operating capability is an improvement over traditional superalloy temperature limits, mechanical strength (e.g., load bearing capacity) of CMCs is also limited by grain growth and reaction processes with the matrix and/or the environment at 1150 C/1350 C and higher. With desired combustion turbine engine firing temperatures as high as 1600-1700 C, the CMCs need additional thermal insulation protection interposed between themselves and the combustion gasses, to maintain their temperature below 1150 C/1350 C. CMCs may advantageously receive additional thermal insulation protection by application of over layer(s) of TBCs, as has been done in the past with superalloy components.

A known type of exemplary, self-supporting, composite turbine blade component 40 is shown in FIG. 2. The composite blade 40 has a known profile sidewall, which forms the blade airfoil, which includes a pressure side 44 and a suction side 46. The sidewall comprises a cigar-like outer wrapping 42 of one or more plies of ceramic reinforcement fabric, embedded within solidified ceramic material. As described above, if used, a TBC is typically applied over the outer wrapping 42. The blade 40 has a hollow internal cavity, delimited by a forward blade cavity 48 and a central blade cavity 50. Internal rib structural support for the composite blade 40 is provided by preform inner wrappings, which are generally rolls of one or more plies of ceramic reinforcement fabric, embedded within solidified ceramic material. The composite blade 40 has a forward inner wrapping (“FIW”) 52 and a central inner wrapping (“CIW”) 54. Portions of the FIW 52 and CIW 54 that bridge the sidewall constitute a substrate rib 55, whose function is similar to that of the reinforcing rib 32 of the cast blade 20, shown in FIG. 1. The forward blade cavity 48 is delimited by the internal circumference of the FIW 52 and the central blade cavity 50 is delimited by the CIW 54. The cavity within the outer wrapping 42 that is aft of the CIW 54, toward the blade 40 tapered trailing edge, is typically filled with additional structural reinforcement fibers and cooling channels, which are not shown.

The composite blade 40 has externally-facing, planar-surfaced, wrapping layers of the abutting outer wrapping (“OW”) 42, FIW 52 and CIW 54, which are only affixed to each other by the solidified ceramic material in which they are mutually embedded. As the composite blade 40 is subjected to axial, radial and torsional loads during engine operation, shearing stresses are generated at the respective surface junctures, which are identified by the reference brackets 56 (the substrate rib 55, formed by FIW 52/CIW 54), 58, 62 (respectively, OW 42/FIW 52), and 60, 64 (respectively, OW 42/CIW 54). If those shearing stresses are not resisted at, the exemplary referenced wrapping surface junctures, one or more of the wrappings may delaminate, damaging the composite blade 40 structure. Shear stress resistance at these exemplary reference locations relies on the bond strength between the solid ceramic material and the wrappings, as well as the shear strength of the solid ceramic material. U.S. Pat. No. 7,799,405, the entire contents of which is incorporated by reference herein, increases delamination resistance between planar, adjoining reinforcement fabric layers by interlocking them relative to each other. Complimentary out-of-plane structural features in one or more fabric layers are interlocked within mating voids or apertures in adjoining one or more fabric layers.

### SUMMARY OF INVENTION

A component for a combustion turbine engine has a ceramic matrix composite (“CMC”) central substrate, having at least one substrate rib that is coupled to and bridges opposed first and second substrate sidewalls, and first pattern of reinforcement fibers embedded within the substrate rib and substrate sidewalls. The first pattern is constructed from a pair of fabric reinforcement sheets, or pairs of multiple-ply sheets. The respective sheet pair (or plies) includes a spine, with coplanar, flanking strips on at least one lateral side of the spine. In some embodiments, the strips are fabricated by lancing the sheets. Alternate rows of strips are folded into pleats that project laterally from the central spine, while the remaining strips remain coplanar with the spine. The respective sheets are oriented with their central spines in opposed and mutually spaced relationship. Pleated strips span across the preform between the first and second sheets. The spines of the respective first and second sheets are embedded within their respective first and second substrate sidewalls. The staggered, commonly aligned and sequentially opposing rows pleats of the respective first and second sheets embedded within the substrate rib and its opposing respective first or second sidewall. The completed, folded fabric structure, if not pre-impregnated with ceramic material prior to folding, is subsequently infiltrated with ceramic slurry and hardened, forming the CMC substrate. In some embodiments, a cured and solidified, fiber-reinforced, ceramic outer wrapping, having embedded therein a second fiber pattern of a third reinforcement fabric, circumscribes the central substrate.

Exemplary embodiments of the CMC components described herein inhibit delamination between abutting or adjoining CMC substrate wrapping layers, by orientation of the staggered, opposed and alternating rows of fabric pleats. The pleats cross laterally from one side of the substrate to the other side of the substrate, which reinforce the substrate rib. Shearing loads applied on the component tension corresponding strips of the pleated fabric, which counteracts the applied load, and reduces shearing forces borne by the solid ceramic portion of the composite body. In this way, the pleats are oriented to dissipate and counter loads on the completed CMC component by tensioning the pleat fabric. Alternating, staggered pleat arrays along the sheet spine assure that there is tensile strength to resist shearing loads on either side of the fabric-reinforced, ceramic substrate, when the component, such as a CMC composite turbine blade or vane, is subjected to axial, bending, or torsional loads.

Exemplary embodiments of the invention feature a ceramic matrix composite (“CMC”) component for a combustion turbine engine, such as a turbine section blade or vane, engine casing lining, combustor basket or combustor transition. The component includes a cured and solidified, reinforced ceramic matrix composite (“CMC”) central substrate, having at least one substrate rib that is coupled to and bridges opposed first and second substrate sidewalls, and a first pattern of reinforcing fibers, such as in some embodiments folded fabric reinforcement sheets, embedded within the substrate rib and substrate sidewalls. The first pattern of reinforcing fibers embedded within the central substrate structure includes respective first and second opposed planar sheets of reinforcement fabric. Both of the first and second sheets respectively form an elongated spine, flanked on at least one side by plural rows of opposed and integral strips. In some embodiments, the reinforcement fabric is lanced to form the strips. In some embodiments, the strips are staggered in alternate sequential rows of flat strips that are coplanar with the spine, and alternate sequential rows of pleated strips that project outwardly from the central spine and the flat strips. The first and second opposed planar sheets are oriented with their respective elongated, central spines in opposed and mutually spaced relationship, so that the pleated strips span across the ceramic substrate between the first and second sheets. The spines of the respective first and second sheets are respectively embedded within their corresponding respective first and second substrate sidewalls. The staggered, commonly aligned and sequentially opposing rows pleats of the respective first and second sheets are embedded within a substrate rib and its opposing respective first or second sidewall. A cured, reinforced CMC outer wrapping, having embedded therein a second preform of third reinforcement fabric, circumscribes the CMC central substrate.

In some embodiments, the pleated strips are formed as rectangular (including square) profiled box pleats, or triangular profile accordion pleats, or undulating pleats having sinusoidal profiles. In some embodiments, axial reinforcing ribs (“ARRs”) are embedded within the substrate rib of the CMC central substrates, abutting the respective pleated strips of the first and second reinforcement fabric sheets. In other embodiments, the ARRs are woven between alternating and aligned respective pleats of the first and second reinforcement fabric sheets, or those of multiple-sheet fabric plies. In some embodiments, an ARR bridges a substrate rib at each location where respective projecting pleats of the first and second reinforcement fabric sheets cross each other. In some embodiments, the pleated strips of one fabric reinforcement sheet are affixed its opposed fabric sheet along their respective abutting surfaces, while in other embodiments, the pleated strips of one fabric reinforcement sheet are slidable relative to its opposed fabric sheet along their respective abutting surfaces. In some embodiments, the CMC substrate circumscribes a CMC inner wrapping. In some embodiments, the component comprises a rotating turbine blade or stationary vane, with the CMC substrate and CMC outer wrapping forming an airfoil portion of the blade, where respective spines of the first and second reinforcement fabric sheets are aligned along an axis from root to tip of the blade. In such embodiments, the CMC substrate first and second sidewalls and the CMC outer wrapping form a sidewall of the airfoil. In other embodiments a thermally sprayed, or vapor deposited, or solution/suspension plasma sprayed thermal barrier coat (“TBC”) is applied over and coupled to the CMC outer wrapping.

Other exemplary embodiments of the invention feature a method for manufacturing a ceramic matrix composite (“CMC”) component for a combustion turbine engine, by fabricating a cured and solidified, reinforced ceramic matrix composite (“CMC”) central substrate, which has at least one substrate rib that is coupled to and bridges opposed first and second substrate sidewalls, and a laid-up, first pattern of reinforcing fibers embedded within the substrate rib and substrate sidewalls. The first fiber pattern in the substrate is made by providing first and second reinforcement fabric sheets and lancing them to form an elongated, central spine flanked on at least one side by plural rows of integral strips. The lanced sheets are then impregnated with ceramic slurry, if they were not already pre-impregnated with ceramic material prior their folding. The plural rows of opposed and integral strips of each respective first and second, impregnated and lanced reinforcement sheet are folded in staggered, alternate sequential rows of strips that are coplanar with the spine. During the sheet-folding, alternate sequential rows of pleated strips are folded to project outwardly from the spine. The first and second opposed planar sheets are oriented with their respective elongated, central spines in opposed and mutually spaced relationship. In this way, the pleated strips span across the fabric-reinforced, ceramic substrate between the first and second sheets. The spines of the respective first and second sheets respectively are embedded within the respective first and second substrate sidewalls. The staggered, commonly aligned and sequentially opposing rows of pleats of the respective first and second sheets are embedded within the substrate rib and its opposing, respective first or second sidewall. A cured and solidified, reinforced CMC outer wrapping is fabricated, by impregnating a second fiber pattern of a third reinforcement fabric with ceramic slurry, unless the third reinforcement fabric was pre-impregnated with ceramic material prior to its laying-up wrapping formation, and wrapping the impregnated, third reinforcement fabric about, and circumscribing the CMC central substrate. All of the reinforcement fabric is infiltrated with ceramic slurry material, if any was not pre-impregnated before folding/wrapping. Thereafter, the infiltrated reinforcement fabric is cured, forming a solidified, fiber-reinforced, ceramic central substrate and outer wrapping of the CMC component.

The respective features of the exemplary embodiments that are described herein may be applied jointly or severally in any combination or sub-combination.

### BRIEF DESCRIPTION OF DRAWINGS

The exemplary embodiments are further described in the following detailed description in conjunction with the accompanying drawings, in which:

FIG. 1 is a partially sectioned, perspective view of a known, metallic construction, turbine blade for a combustion turbine engine;

FIG. 2 is a cross-sectional, plan view of a known, ceramic matrix composite (“CMC”) construction, turbine blade for a combustion turbine engine;

FIG. 3 is a cross-sectional, plan view of a ceramic matrix composite (“CMC”), turbine blade for a combustion turbine engine, that is constructed accordance with an embodiment disclosed herein;

FIG. 4 is a schematic plan view of representative, axially adjoining and opposed, laid-up, pleated fabric layers of first and second fabric sheets, which in combination form a first pattern of reinforcing fibers that is constructed in accordance with an embodiment disclosed herein, which are shifted laterally in the figure, for ease of viewing the lower pleated fabric layer;

FIG. 5 is a schematic, line drawing of the first and second fabric layers of the first reinforcing fiber pattern of FIG. 4, which has been extended on the right hand side of the figure;

FIG. 6 is a cross-sectional, plan view of another embodiment of a ceramic matrix composite (“CMC”), turbine blade for a combustion turbine engine, similar to that of FIG. 3, including axially-aligned, axial reinforcement ribs (“ARRs”) interposed at the first and second pleated fabric layer intersections;

FIG. 7 is a schematic, line drawing of the first and second fabric layers of a first pattern of reinforcing fibers that is constructed accordance with an embodiment disclosed herein, which is similar to that of FIG. 5, but with addition of ARRs, and additionally showing “strong” ARR reinforcement, at first and second pleated fabric layer intersections where the fabric pleats cross each other, and intersections where the fabric pleats do not cross each other;

FIG. 8 is a schematic, line drawing of the first and second fabric layers and ARRs of a first pattern of reinforcing fibers that is constructed accordance with another embodiment disclosed herein, showing paired ARRs oriented on each side of the first and second pleated fabric layer intersections where the fabric pleats cross each other, so that there is a “strong” rib reinforcement on both sides of the central substrate at each adjoining first and second fabric layer;

FIG. 9 is a schematic, line drawing of the first and second fabric layers and axially-aligned reinforcement ribs of a central substrate that is constructed accordance with another embodiment disclosed herein, showing accordion and trapezoidal profile pleats, with paired ribs oriented on each side of the first and second pleated fabric layer intersections where the fabric pleats cross each other, so that there is a “strong” rib reinforcement on one side of the central substrate, and where the rib is captured between adjoining first and second fabric layers on the other side of the central substrate;

FIG. 10 is an exploded, perspective view of an exemplary CMC component embodiment, showing lancing and folding of planar first and second fabric sheets into a laid-up, first fiber pattern for a central substrate;

FIG. 11 is an edge perspective view of the fully fabricated, laid-up first fiber pattern of FIG. 10; and

FIG. 12 is an elevational perspective view of a fully fabricated CMC component, which incorporates the laid-up, first pattern of reinforcing fibers in the central substrate of FIG. 10.

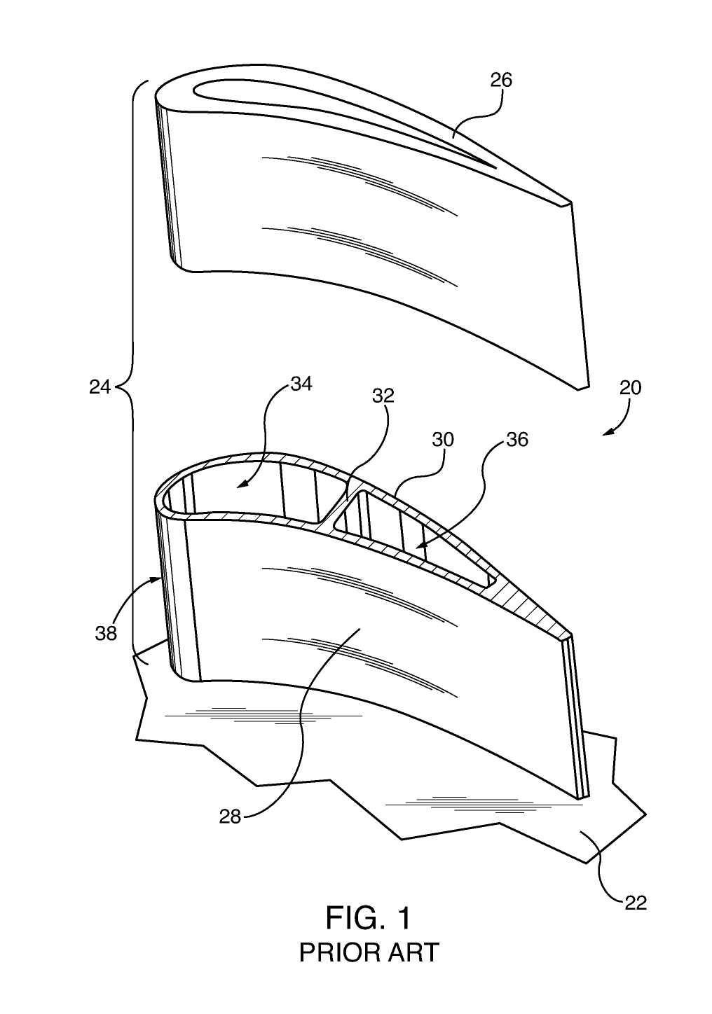

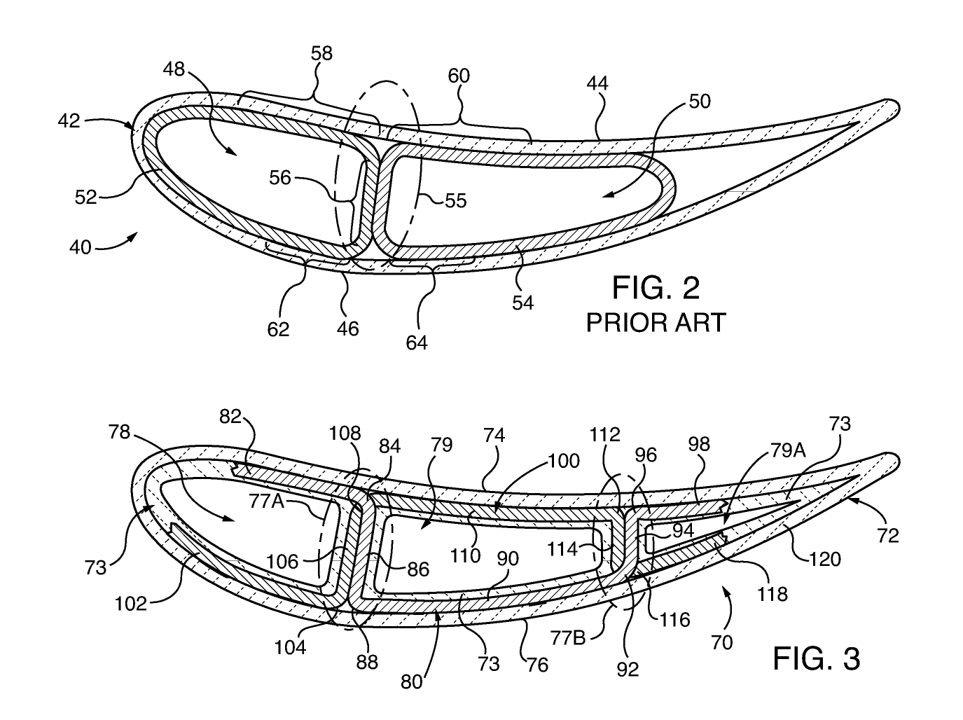

To facilitate understanding, identical reference numerals have been used, where possible, to designate identical elements that are common to the figures.

### DESCRIPTION OF EMBODIMENTS

Exemplary embodiments described herein are utilized in components for combustion turbine engines. Exemplary self-supporting CMC component embodiments include rotating blades or stationary vanes in compressor or turbine sections of the engine, and internal subcomponents of combustors or transitions. In some embodiments, the components are CMC blade or vane airfoils, having self-supporting or metal-supported central substrate with a TBC layer over the central substrate. In some embodiments, the central substrate has an embedded first pattern of reinforcing fibers, including a laid-up pair of first and second fabric reinforcement sheets or multiple-sheet plies, including a spine, with coplanar, flanking strips. Alternate rows of strips are folded into pleats that project from the spine. The respective sheets are oriented with their spines in opposed and mutually spaced relationship. The pleated strips span across the first fiber pattern between the first and second sheets, with the spines of the respective first and second sheets respectively embedded within the respective first and second substrate sidewalls. Staggered, commonly aligned, and sequentially opposing rows pleats of the respective first and second sheets are embedded within a substrate rib and its opposing respective first or second sidewall. The fibers in the first fiber pattern are infiltrated with ceramic slurry (pre-impregnated before, or after the lay-up folding) and hardened, forming the solidified, ceramic central substrate. The staggered, crisscrossing fabric pleats interlock reinforcement fabric layers, reducing likelihood of delamination between abutting layers.

In exemplary embodiment turbine blades and vanes, alternating rows of staggered strip fabric reinforcement in the fiber pattern of the central substrate are oriented within substrate ribs that bridge respective pressure and suction sides of the substrate sidewalls and the respective sidewalls of the airfoil, which allows the central substrate to carry loads, by tensioning the reinforcement fabric from one side of the airfoil to the other, e.g., from the pressure side to the suction side of the airfoil. A load on either side of the airfoil is resisted by tensioned fabric. In some embodiments, additional structural reinforcement is provided by axial reinforcing ribs (“ARRs”), which in some embodiments are woven through opposed, crossing pleats. The following turbine blade airfoils, with the exemplary central substrate embodiments described herein, illustrate application of the invention. The same features are applicable to other types of CMC components for combustion turbine engines, including stationary vane airfoils, combustor baskets, and combustor transitions.

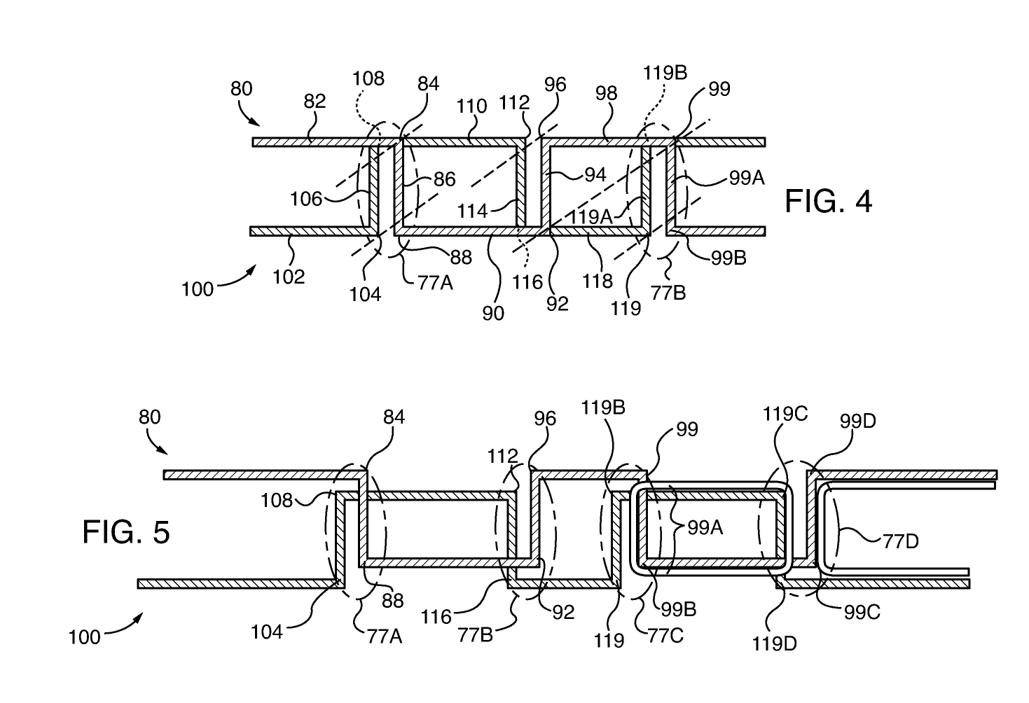

In FIG. 3 is a plan cross-sectional view of a CMC turbine blade airfoil 70, with a cured and solidified, fiber-reinforced ceramic outer wrapping or overwrapping 72 forming the airfoil sidewall outer profile, along with a cured and solidified, fiber-reinforced, ceramic central substrate 73. The sidewall 74 of the pressure side and the sidewall 76 of the suction side of the airfoil 70 are bridged by a forward substrate rib 77A and an aft substrate rib 77B. A forward internal cavity 78, central internal cavity 79, and aft cavity 79A are delimited by the CMC substrate 73 and the respective forward and aft substrate ribs 77A, 77B. Typically, the aft cavity 79A is reinforced with structural filler and trailing edge cooling passages, which is not shown. Embedded within the central substrate 73 is a first pattern of reinforcing fibers, which includes first fabric reinforcement sheet 80 and second fabric reinforcement sheet 100. The first and second fabric reinforcement sheets 80, 100 comprise single- or multiple-layered plies. The outer wrapping 72 comprises a second fiber pattern of a third reinforcement fabric, which includes one or a plurality of reinforcing fabric plies. In the blade 70 embodiment, the fabric sheets 80 and 100 are vertically aligned in these figures, in staggered alternating rows, in a repeating pleat pattern. FIG. 3, and the simplified schematic FIGS. 4 and 5, shifts strip portions of the respective reinforcement fabric 80 and 100 laterally or diagonally in a perspective view, in order to show clearly adjoining fabric profiles, including pleat profiles, which profiles will be described in detail herein.

Referring also to the simplified schematic views of FIGS. 4 and 5, as well as FIG. 3, the first reinforcement fabric sheet 80, or a plurality of plies of such fabric reinforcement sheet, is embedded within the central substrate 73 on the suction side 76 of the blade airfoil 70. The first fabric sheet 80 is formed into an elongated spine segment 90, which is oriented in alignment with the blade airfoil axis (in and out of FIG. 3), and which has a sequential series of lateral fabric strips flanking one or both sides of the spine. Here in this embodiment, fabric strips flank both sides of the spine 90. The fabric strips are sequentially stacked in the axial direction as alternating flat and pleated strips. The flat strips of the first fabric sheet 80 are not shown. Each pleated, first fabric strip has a generally box-pleat profile, and follows an undulating path, with a segment 82 embedded within the pressure side 74 of the central substrate 73, bending sharply at 84, traversing the blade forward and central internal cavities 78, 79 along segment 86, where it is embedded within and reinforces the forward substrate rib 77A. After turning sharply toward the aft or trailing edge of the blade at the fabric bend 88, the spine segment 90 of the first pleated fabric strip 80 is embedded within the suction side 76 of the central substrate 73. The first fabric reinforcement strip 80 bends inwardly at 92, with the segment 94 embedded within and reinforcing the aft substrate rib 77B, as it bridges across the aft cavity 79A, and bends again at 96, with the segment 98 embedded within the pressure sidewall 74 of the central substrate 73, toward the aft trailing edge of the airfoil 70. The fabric segment 98 is directed toward the airfoil 70 trailing edge. In some embodiments, the distal ends of the fabric segments 82 and 98 are woven into and comingled with strips of the outer wrapping 72, for enhanced structural support and reduced likelihood of delamination within the outer wrapping 72, the central substrate 73 or their respective adjoining interfaces. The spine segment 90 extends axially (in and out of the drawing sheet of FIG. 3) where it is anchored to other flanking fabric strips. Other flanking strips are staggered above and below the spine segment 90 of the first reinforcement fabric strip 80, which is embedded within the solidified, ceramic central substrate 73, which resist tension loads that are attempting to separate the pressure 74 and suction side 76 of the CMC airfoil 70 axially along the airfoil.

A second fabric reinforcement sheet 100, or a plurality of plies of such fabric reinforcement sheet, is embedded within the central substrate 73 on the suction side 76 of the blade airfoil 70; it has a general construction the same as, or substantially similar to the first reinforcement fabric sheet 80. The second fabric sheet 100 is formed into an elongated spine segment 110, which is oriented in alignment with the blade airfoil axis (in and out of FIG. 3), and which has a sequential series of lateral fabric strips flanking one or both sides of the spine. Here, fabric strips flank both sides of the spine 110. The fabric strips are sequentially stacked in the axial direction as alternating flat and pleated strips. The flat strips of the second fabric sheet 100 are not shown. Each pleated second fabric strip is oriented in a row immediately above or below a strip of the first fabric sheet 80, traversing back and forth from the blade pressure side 74 to the blade suction side 76, in directions that are opposite to those of the corresponding pleated strips of the first fabric reinforcement 80. The pleated strip of the second reinforcement fabric sheet 100, has a generally box-pleat profile, and follows an undulating path, with a segment 102 abutting the suction side 76 of the central substrate 73 and outer wrapping 72, bending sharply at 104, traversing the blade forward and central internal cavities 78, 79 along segment 106, where it also reinforces the forward substrate rib 77A. After turning sharply toward the aft or trailing edge of the blade at the fabric bend 108, the spine segment 110 of the second pleated fabric strip 100 is embedded within the solidified ceramic material on the pressure side 74 of the central substrate 73 and the outer wrapping 72. The second fabric reinforcement strip 100 bends inwardly at 112, with the segment 114 reinforcing the aft substrate rib 77B, as it bridges across the aft cavity 79A, and bends again at 116, with the segment 118, embedded within the suction sidewall 76 of the central ceramic substrate 73 and outer wrapping 72, toward the aft trailing edge of the airfoil 70. The fabric segment 118 is directed toward the airfoil 70 trailing edge. In some embodiments, the distal ends of the fabric segments 102 and 118 are woven into and comingled with strips of the outer wrapping 72, as described with respect to the first fabric distal end segments 82 and 98, for enhanced structural support and reduced likelihood of delamination. The spine segment 110 extends axially (in and out of the drawing sheet of FIG. 3) where it is anchored to other flanking fabric strips. Other fabric strips of the second reinforcing fabric sheet 100 are staggered above and below the fabric strip shown in the figure, which resist tension loads that are attempting to separate the pressure 74 and suction side 76 of the CMC airfoil 70, axially along the airfoil.

In the embodiment of FIGS. 4 and 5, the first fabric sheet 80 and second fabric sheet 100 have pleats extending aft from the fabric strip segments 98 and 118. In FIG. 4, a third or aft substrate rib 77B is reinforced by first fabric sheet 80, by addition of reinforcement fabric pleats 99, 99A, and 99B. The aft substrate rib 77B is also reinforced by the second fabric sheet 100, by addition of reinforcement fabric pleats 119, 119A, and 119B. In FIG. 5, third substrate rib 77C and fourth substrate rib 77D are reinforced by additional pleats, 99B, 99C, 99D, which are formed in the first fabric sheet 80. Similarly, the third substrate rib 77C and fourth substrate rib 77D are reinforced by additional pleats, 119B, 119C, and 119D, which are formed in the second fabric sheet 100.

Referring to FIG. 3, the CMC outer wrapping 72, which forms the airfoil sidewall outer profile along with the central substrate 73, includes a second fiber pattern of a third fabric reinforcement sheet 120, or a plurality of stacked plies of third fabric reinforcement sheets. The third fabric reinforcement sheet is embedded in hardened, solid ceramic. An optional, thermally sprayed, vapor deposited, or solution/suspension plasma sprayed thermal barrier coat (“TBC”) is applied over and coupled to the outer surface of the CMC outer wrapping 72.

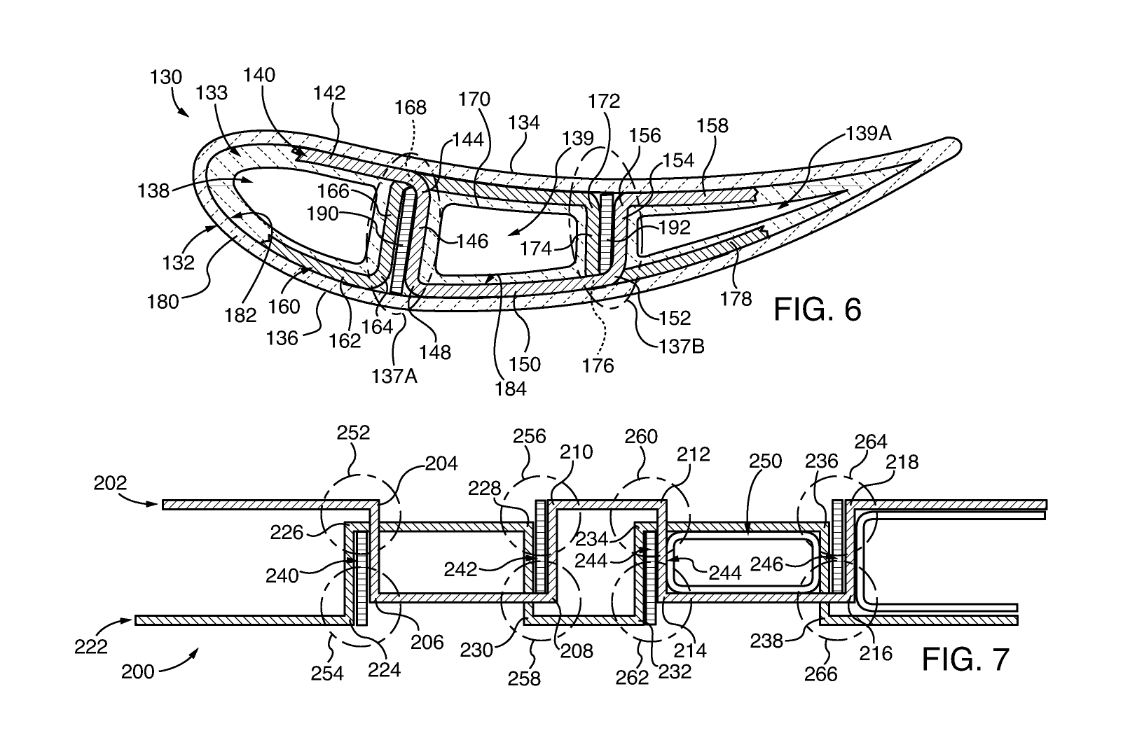

FIG. 6 is a plan cross-sectional view of another embodiment of a CMC turbine blade airfoil 130, with an outer wrapping or overwrapping 132 forming the airfoil sidewall outer profile. The outer wrapping 132 comprises one or a plurality of reinforcing fabric plies, which are embedded within the fiber-reinforced ceramic central substrate 133. The blade airfoil 130 is generally of similar construction to the airfoil 70, but additionally embeds axial reinforcement ribs (“ARRs”) 190 and 192 in the forward substrate rib 137A and the aft substrate rib 137B. The ARRs 190 and 192 extend axially through the turbine blade. The sidewall 134 of the pressure side and the sidewall 136 of the suction side, both of which are part of the CMC ceramic substrate 133, are bridged by a forward substrate rib 137A and an aft substrate rib 137B. A forward internal cavity 138, central internal cavity 139, and aft cavity 139A are delimited by the central substrate 133 and the respective forward and aft substrate ribs 137A, 137B. Typically, the aft cavity 139A is reinforced with structural filler and trailing edge cooling passages, which are not shown. Embedded within the central substrate 133 is a first fiber pattern of reinforcing fibers, which includes first fabric reinforcement sheet 140 and second fabric reinforcement sheet 160 (or multiple-ply reinforcement sheets of).

In FIG. 6, the first fabric sheet 140 is formed into an elongated spine segment 150, which is oriented in alignment with the blade airfoil 130 axis (in and out of the figure), and which has a sequential series of lateral fabric strips flanking one or both sides of the spine. Here in this embodiment, fabric strips flank both sides of the spine 150. The fabric strips are sequentially stacked in the axial direction as alternating flat and pleated strips. The flat strips of the first fabric sheet 140 are not shown. Each pleated, first fabric strip has a generally box-pleat profile, and follows an undulating path, with a segment 142 embedded within the pressure side 134 of the central substrate 133, bending sharply at 144, traversing the blade forward and central internal cavities 138, 139 along segment 146, where it is embedded within and reinforces the forward substrate rib 137A. After turning sharply toward the aft or trailing edge of the blade at the fabric bend 148, the spine segment 150 of the first pleated fabric strip 140 is embedded within the suction side 136 of the central substrate 133. The first fabric reinforcement strip 140 bends inwardly at 152, with the segment 154 embedded within and reinforcing the aft substrate rib 137B, as it bridges across the aft cavity 139A, and bends again at 156, with the segment 158 embedded within the pressure sidewall 134 of the CMC substrate 133, toward the aft trailing edge of the airfoil 130. The fabric segment 158 is directed toward the airfoil 130 trailing edge. In some embodiments, the distal ends of the fabric segments 142 and 158 are woven into and comingled with strips of the outer wrapping 132, for enhanced structural support and reduced likelihood of CMC layer delamination. The spine segment 150 extends axially (in and out of the drawing sheet of FIG. 6) where it is anchored to other flanking fabric strips. Other flanking strips are staggered above and below the spine segment 150 of the first reinforcement fabric strip 140, which resist tension loads that are attempting to separate the pressure 134 and suction side 136 of the CMC airfoil 130 axially along the airfoil.

Furthermore, in the airfoil 130 embodiment, a second fabric reinforcement fabric sheet 160, or a plurality of plies of such fabric reinforcement sheet, is embedded within the CMC central substrate 133 on the suction side 136 of the blade airfoil 130; it has a general construction the same as, or substantially similar to the first reinforcement fabric sheet 140. The second fabric sheet 160 is formed into an elongated spine segment 170, which is oriented in alignment with the blade airfoil axis (in and out of FIG. 6), and which has a sequential series of lateral fabric strips flanking one or both sides of the spine. Here, fabric strips flank both sides of the spine 170. The fabric strips are sequentially stacked in the axial direction as alternating flat and pleated strips. The flat strips of the second fabric sheet 160 are not shown. Each pleated second fabric strip is oriented in a row immediately above or below a strip of the first fabric sheet 140, traversing back and forth from the blade pressure side 134 to the blade suction side 136, in directions that are opposite to those of the corresponding pleated strips of the first fabric reinforcement 140. The pleated strip of the second reinforcement fabric sheet 160, has a generally box-pleat profile, and follows an undulating path, with a segment 162 abutting the suction side 136 of the central substrate 133 and outer wrapping 132, bending sharply at 164, traversing the blade forward and central internal cavities 138, 139 along segment 166, where it also reinforces the forward substrate rib 137A. After turning sharply toward the aft or trailing edge of the blade at the fabric bend 168, the spine segment 170 of the second pleated fabric strip 160 is embedded within the pressure side 134 of the central substrate 133 and the outer wrapping 132. The second fabric reinforcement strip 160 bends inwardly at 172, with the segment 174 reinforcing the aft substrate rib 137B, as it bridges across the aft cavity 139A, and bends again at 176, with the segment 178, embedded within the suction sidewall 136 of the ceramic, central substrate 133 and outer wrapping 132, toward the aft trailing edge of the airfoil 130. The fabric segment 178 is directed toward the airfoil trailing edge. In some embodiments, the distal ends of the fabric segments 162 and 178 are woven into and comingled with strips of the outer wrapping 132, for enhanced structural support and reduced likelihood of layer delamination. The spine segment 170 extends axially (in and out of the drawing sheet of FIG. 6) where it is anchored to other flanking fabric strips. Other fabric strips of the second reinforcing fabric sheet 160 are staggered above and below the fabric strip shown in the figure, which resist tension loads that are attempting to separate the pressure 134 and suction side 136, axially along the airfoil 130.

The embodiment of FIG. 7 shows fabric sheet fold patterns in the first fiber pattern of the central substrate 200, similar to that of FIG. 5, but without surrounding airfoil structure. The first fabric sheet 202 defines a strip portion, between the pleats 204 and 206, ultimately that will be embedded within a substrate rib, as is the counterpart strip portion of the second fabric sheet 222, between the pleats 224 and 226. An ARR 240 will be embedded within the same substrate rib, as are the corresponding segment portions of the first fabric sheet 202 and the second fabric sheet 222. In the circled zone 252, at the crisscrossing of the corresponding pleat bends 204 and 226 the respective pleated strips of the reinforcing fabric sheets 202 and 222 provide tensioned fabric support to the ARR 240 and surrounding ceramic central substrate and wrapping layers (not shown), to resist shearing loads applied in the upwardly direction in FIG. 7. The crisscrossing, pleated reinforcement fabric strips thus provide a “strong” bond in the zone 252. However, downwardly directed shearing loads applied against the central substrate 200 in the zone 254 have no corresponding crisscrossing pleated fabric strips, potentially increasing delamination risk among adjoining wrapping fabric layers.

The “strong” and unsupported bond zones are reversed in the next preform-pleated fabric crossing at the ARR 242, in FIG. 7. Here the “strong” bond is in the zone 258, where the pleated fabric, crisscrossing strips are located at the fabric bends 208 and 230, while the fabric bends at 210 and 228 have no pleated strip-crossing zone at 256. The pleated fabric weaving reverses at ARR 244, where the strong bond at zone 260 is supported by the crisscrossing pleated fabric bends 212 and 234. However, the bends at 214 and 232 in zone 262 do not crisscross. Additional delamination resistance in zone 262 is provided by the CMC internal wrapping 250 that is circumscribed by the preform 200 (and the not shown corresponding CMC ceramic central substrate and CMC outer wrapping). Similarly, the CMC internal wrapping also increases delamination resistance at its other adjoining ARR 246, where the strong bond zone 266, at the juncture of the crisscrossing pleated bends 216 and 238, is on the opposite side of the preform from the strong bond zone 260. The zone 264 is weaker than the strong bond zone 260, because the pleated bends 218 and 236 do not cross. In any embodiment incorporating ARRs, they are embedded in proximity, or abutting the corresponding reinforcing fabric pleats, or alternatively in other embodiments the ARRs are interwoven between sequential pleats of the respective first and second reinforcement fabric sheets (or stacks of sheet plies in multi-layer reinforced fabric construction first fiber pattern).

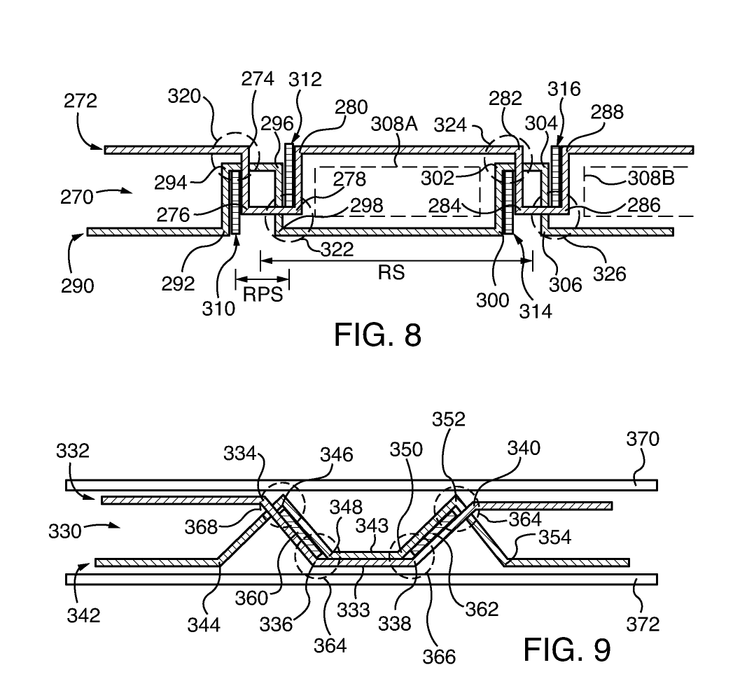

The central substrate 270 embodiment of FIG. 8 counters the disadvantages of opposed “strong” bond zones, where there are crisscrossing reinforcement fabric pleats, and unsupported zones, where the corresponding fabric pleats do not cross. Here the axial reinforcement ribs ARRs are paired by having closer lateral spacing (“RPS”), than the rib spacing (“RS”) of the substrate ribs. In other words, each substrate rib (denoted by the dashed lines 308A and 308B) incorporates a pair of ARRs. In FIG. 8, the paired ARRs 310 and 312 have relatively closely laterally aligned strong bond zones 320 (crisscrossing pleats 274 and 294) and 322 (crisscrossing pleats 278 and 298) on opposite sides of the preform 270, assuring a strong bond on each side of the corresponding central substrate rib 308A, despite the fact that the pleat pairs 276/292 and 280/296 are not similarly supported. The next set of paired ARRs 314 and 316 are at the other substrate rib 308B, spaced the distance RS from the substrate rib 308A. There the strong bond in zone 324 is formed by the crisscrossing pleats 282/302 and the strong bond in zone 326 is formed by the crisscrossing pleats 286/306, despite the fact that the pleat pairs 284/300 and 288/304 are not similarly supported.

FIG. 9 shows a first fiber pattern 330 embodiment that is not yet embedded within a solid ceramic portion of a surrounding CMC component for a gas turbine engine. The first fiber pattern 330 incorporates trapezoidal and triangular pleats in its respective first and second reinforcing fabric layers 332 and 342. The first reinforcing fabric layer 332 has a spine 333 that is axially aligned with a long axis of the component, e.g. in a composite turbine blade airfoil, with the spine in and out of the drawing figure, axially aligned with the blade long axis from blade root to blade tip. The spine 333 adjoins, and/or is interwoven with an outer wrapping layer 372 on one side of the airfoil sidewall; it comprises staggered rows of flat and pleated strips. The flat strips are not shown. Axially sequential, staggered rows of trapezoidal pleated strips are defined by the pleat bends 334, 336, 338, and 340. The trapezoidal pleat pattern flanks the left and right sides of the spine 333. In some embodiments, the trapezoidal pattern is repeated outboard of the respective pleat bends outboard of the zones 368 and 369. In others, remnant strip outboard of those zones is interwoven with the outer wrap 370. Similarly, the second reinforcing fabric layer 342 has a spine 343 that is axially aligned with a long axis of the component, e.g. in a composite turbine blade airfoil, with the spine in and out of the drawing figure, axially aligned with the blade long axis from blade root to blade tip. The spine 343 adjoins, and/or is interwoven with an outer wrapping layer 372 and/or is interwoven or otherwise affixed to the spine 333 of the first fabric layer 332. The second fabric layer 342 also comprises staggered rows of flat and pleated strips. The flat strips are not shown. Axially sequential, staggered rows of triangular or accordion pleated strips are defined by the pleat bends 344, 346, 348, 350, and 352. The triangular pleat pattern flanks the left and right sides of the spine 343. In some embodiments, the triangular pattern is repeated outboard of the respective pleat bends outboard of the zones 368 and 369. In others, remnant strip outboard of those zones is interwoven with the outer wrap 370.

In the embodiment of FIG. 9, axial reinforcing ribs 360 and 362 are captured between the respective pleats of the first and second reinforcing fabric sheets 332, 342, by plain abutment or by interweaving the ARRs between sequential pleats of each respective fabric sheet. Both sides of each of the ARRs 360 and 362 have “strong” bonds with the fabric pleats formed by the reinforcement fabric sheets or layers 332 and 342. At the bond zones 368 and 369, apexes of the fabric pleats from the respective sheets 332 and 342 crisscross each other at their intersection with the AARs 360 and 362, providing tension resistance against forces that urge the AARs against the outer wrap 370. At the bond zones, 364 and 366 the AARs 360 and 362 are sandwiched between the fabric sheets 332 and 342, providing tension resistance by tensioned strips of fabric sheet 332 against forces that urge the AARs against the outer wrap 372.

In some embodiments of FIG. 9, the abutting spine portions 333 and 343 of the first and second fabric sheets 332 and 342 are bonded to each other and the airfoil outer wrapping 372, providing additional axial (in and out of the figure) and shear deformation resistance in the bond zones 364 and 366. In contrast, the first and second pleated strips at the apexes of the triangular, crossing pleats intersections at the bond zones 368 and 369 have axially-aligned, single-point contact with their corresponding airfoil outer wrapping 370, allowing greater flexure of the airfoil outer wrapping 370, compared to the more rigid bond zones 364 and 366 on the opposite side of the airfoil outer wrapping 372. In some embodiments, even greater flexure of the structure is achieved by allowing one or more of the first and second fabric sheets 332, 342 and/or the airfoil outer wrapping to be slidable relative to each other. Relative sliding between fabric sheets 332, 342, is achieved by selectively preventing bonding of the fabric sheets and/or the airfoil outer wrapping 372 to each other, or by creating a relatively weak bond that is broken during operation of the component within a combustion turbine engine. One way to break a relatively weak bond between abutting or adjacent reinforcement fiber layers is to facilitate controlled and limited delamination between the fiber layers. Flexure “tuning” by selectively varying structural rigidity within different portions of the fiber reinforced, solidified ceramic CMC component, such as the airfoil 330 is accomplished with or without use of AARs 360 or 362.

By selectively “tuning” flexure along abutting or adjoining fiber layers with the ceramic substrate of the CMC, (e.g., wrapped fabric layers), structural rigidity of the CMC component is selectively varied. By way of example, referring generally to FIGS. 3 and 9, when the suction side 76 of the airfoil 70 incorporates the concept of the adjoining fabric spines 333 and 343 and outer wrapping 372 of FIG. 9, and when its pressure side 74 incorporates the slidable fabric orientation of the bond zones 368 and 369 of FIG. 9, a turbine blade or vane can carry most of the internal pressure loads of the airfoil, while the pressure side has greater flexure resilience to resist transient thermal gradients and pressure pulsations imparted by combustion gasses.

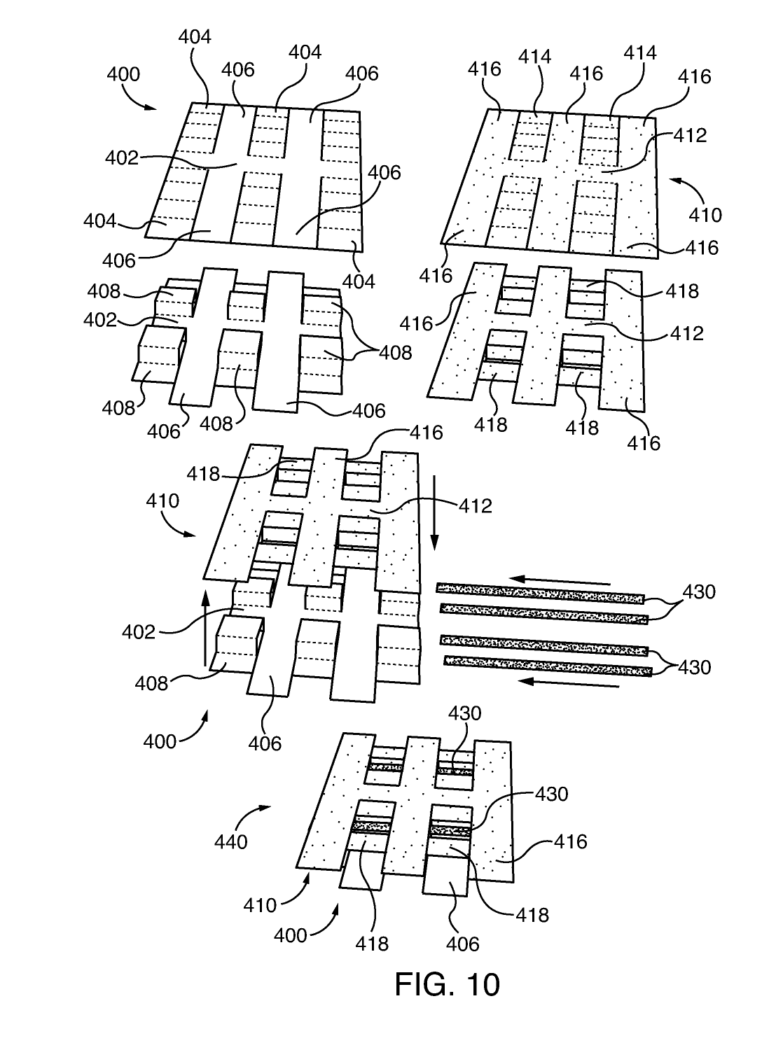

FIG. 10 is an exploded laying-up, or assembly sequence, of an exemplary fiber pattern, layered structure 440, which will form a fiber-reinforced, solidified ceramic CMC substrate. Using any known technique, ceramic fibers are laid-up into the layered structure of the fiber pattern 440. Exemplary layered structures, such as the fiber pattern 440, are laid-up by orienting ceramic fibers into symmetrical or asymmetrical patterns. In some embodiments, the fibers are already incorporated into a two- or three-dimensional fabric weave, or various fabric bundles, or within non-woven scrim fabric, ready to be laid-up into the layered structure. In some embodiments, the fiber pattern is selectively varied to provide anisotropic structural properties, for example if the finished CMC component is to function as a self-supporting or partially self-supporting structural element, as opposed to a non-structural insulative cover over a metallic member or another substrate.

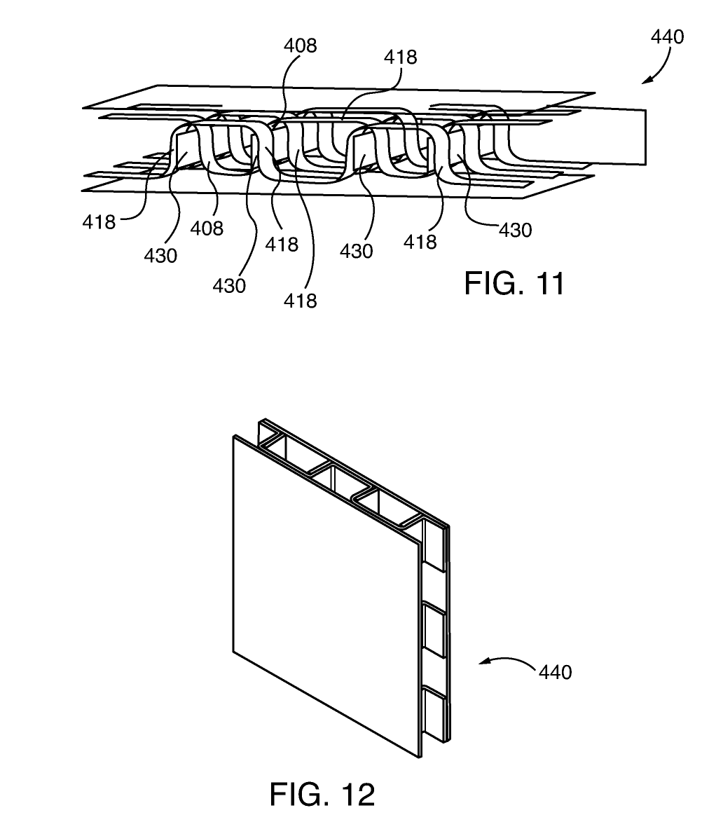

The fiber pattern, layered structure illustrated in FIGS. 10-12 is laid-up by folding of a pair of flat, first reinforcement fabric sheet 400 and second reinforcement fabric sheet 410. In some embodiments, multi-ply fabric sheets are substituted for the exemplary single reinforcement sheets 400 and 410. The fiber material properties and its construction within the layers of the fabric reinforcement sheets 400 and 410, as well as their orientation within the fiber layers 440, are selected to vary locally structural strength, as well as to enhance impregnated ceramic slurry material or TBC anchoring capabilities. The layered fabric's surface 400, 410 texture (e.g., within a two- or three-dimensional weave pattern fabric or non-woven scrim fabric, or any other type of fabric that incorporates braids or tows) can be selectively varied during its laying-up or prior to the lay-up by selecting fabrics with desired fiber patterns. In some embodiments, the laid-up fiber surface texture is varied through application of different scrim fabric fiber spacing and/or fiber thickness, or weave/tow patterns within woven fabrics. This allows selective alteration of fiber orientation and anisotropic structural strength in some layers or zones within the fiber-reinforced ceramic substrate. By way of further example, the axial reinforcing ribs (“ARRs”), such any one or more of the rib embodiments 190, 192, 240, 242, 244, 246 310, 312, 314, 316, 360 or 362, are constructed with uniaxial reinforced woven fabric, scrim fabric, tows and/or braids.

In some embodiments, the fiber-reinforced ceramic substrate 73 of FIG. 3, or 133 of FIG. 6, or 330 of FIG. 9, or 440 of FIGS. 10-12 within the CMC composite component, is made from: (i) oxide ceramic fibers (e.g., yttrium aluminum garnet (“YAG”) fibers commercially available under the trademarks NEXTEL® 440, NEXTEL® 610, and NEXTEL® 720), or alternatively, zirconium oxide (“ZrO₂”); (ii) glass or glassy fibers (e.g., commercially available under the trademarks NEXTEL® 312, Fiberglass, E-glass); or (iii) non-oxide ceramic fibers (silicon carbide (“SiC”), or alternatively, silicon carbon nitride (“SiCN”)). Oxide ceramic fiber composites are typically formed using oxide ceramic slurry, such as alumina, mullite, zirconia, or zirconia toughened alumina (“ZTA”). Glass fiber composites typically have a glassy matrix. Non-oxide fiber ceramics (typically SiC, commercially available under trademarks SYLRAMIC®, HI-NICALON®, TYRANO®) are formed using a non-oxide ceramic matrix (SiC, SiCN) from ceramic powders, ceramic precursors (silicon polyborosilazane), chemical vapor infiltration, or melt infiltrated processing.

As previously noted, in some embodiments, the fibers used to lay-up the layered structure that is incorporated into the fiber-reinforced ceramic substrate 73 of FIG. 3, or 133 of FIG. 6, or 330 of FIG. 9, or 440 of FIGS. 10-12, within the CMC composite component, are pre-impregnated with ceramic material (“pre-preg” fiber or fabrics). After the pre-preg lay-up is completed, it is cured into the solidified and hardened fiber-reinforced ceramic substrate, which is in turn processed into the final CMC component, such as a rotating turbine blade or stationary vane. If pre-preg fiber material is not utilized, it is laid-up into a layered structure, which is subsequently impregnated with ceramic material prior to curing, solidification, and hardening into the fiber-reinforced ceramic substrate. Exemplary ceramic materials used to impregnate the layered structure, for subsequent solidification into the fiber-reinforced ceramic substrate, include alumina silicate, alumina zirconia, alumina, yttria stabilized zirconia, silicon, or silicon carbide polymer precursors. The post lay-up infiltration is performed, by any known technique, including gas deposition, melt infiltration, chemical vapor infiltration, slurry infiltration, preceramic polymer pyrolysis, chemical reactions, sintering, or electrophoretic deposition of ceramic powders, creating a solid, fiber-reinforced ceramic structure with embedded, ceramic fiber layers.

In the laying-up, or assembly sequence, of the first fiber pattern 440, the respective fabric sheets 400 and 410 are lanced on their peripheral margins. After lancing, the first fabric sheet 400 has an elongated spine 402, with a sequential series of alternating strips 404 and 406 flanking both sides of the spine 402. Similarly, after lancing the second fabric sheet 410 has a central spine 412 and a sequential series of alternating strips 414 and 416 flanking both sides of the spine 412. In other embodiments, the strips 404, 406, 414, and 416 are formed only on one side of the respective spines 402 or 412.

The alternating, sequential strips 404 and 414 respectively are folded into respective pleats 408 and 418, which here are shown as rectangular box pleats. Alternatively, as previously discussed, other pleat profiles are utilized in other embodiments, such as by non-limiting example square pleats, accordion pleats, sinusoidal pleats or trapezoidal pleats. While only one full pleat 408, 418 is shown in each of the respective strips 404 and 414, in other embodiments, a series of multiple repetitive pleats is formed in each strip. Beneficially, the fabric sheets 400 and 410 are pre-impregnated with an adhesive resin and/or ceramic slurry that facilitates adherence of the pleats 408, 418 to other fabric surfaces during the sheet folding sequence. A three-dimensional assembly jig or molds (not shown) beneficially help fold or otherwise shape the fabric strips and pleats 404, 406, 408, 414, 416 and 418.

After formation of the pleats, the respective spines 402 and 412 are axially aligned, with the respective, alternating sequential rows of pleats 408 and 418 aligned with an opposed, corresponding flat strip 406 or 416 on the other sheet. The respective fabric sheets 400 and 410 are pressed against each other, so that each pleat 408 or 418 is in abutting contact with an opposed flat strip 416 or 406. Referring to FIGS. 10-12, the assembled fabric sheets 400 and 410 now form a first fiber pattern, wherein the opposed, sequential array of pleats 408 and 418 are axially aligned, interlocking and have sequential, crisscrossing pleats along the elongated spines 402 and 412. Optionally, axial reinforcement ribs (“ARRs”) 430 are inserted axially, in alignment with the respective spines 402, 412 elongated dimension, bridging the first fiber pattern 440 between the opposed fabric sheets 400 and 410. In some embodiments, one or more of the ARRs 430 is interwoven between opposed, sequential pleats 408 and 418.

After the fiber pattern 440 is laid-up, its ceramic fibers in the fiber reinforcement sheets 400 and 410 are infiltrated ceramic material (if not already incorporated within pre-impregnated fabric, or if additional ceramic material is to be added to the folded fabric), to form a solidified ceramic substrate. Where the CMC substrate is an oxide ceramic matrix composite, the solidified ceramic substrate incorporates the first pattern of laid-up fibers. The solidified ceramic substrate is impregnated with slurry of alumina silicate or alumina zirconia ceramic oxide material. The slurry impregnated preform is then fired to harden the slurry, using known ceramic production techniques, forming the solidified ceramic substrate. In some embodiments, flexible ceramic pre-pregs are used to form the solidified ceramic substrate.

After infiltration of the fabricated preform 440 with ceramic slurry, and subsequent air-drying, it is transformed into a “green”, uncured CMC substrate for a CMC component. Optionally, and frequently, the uncured CMC substrate is combined with CMC inner wrappings or CMC outer wrappings, in order to fabricate a CMC component, such as a turbine blade, vane, combustor transition or other component for a gas or combustion turbine engine. As noted above, the “green” component is heated and cured, using known ceramic curing processes, to form the CMC substrate and any other CMC structures that are affixed to the substrate prior to its curing. Thereafter, the CMC substrate undergoes further fabrication processes, such as application of an optional thermal barrier coating (“TB C”).

In some embodiments, a known composition, thermally sprayed, or vapor deposited, or solution/suspension plasma sprayed thermal barrier coat (“TBC”) is applied over the ceramic substrate. Exemplary TBC compositions include single layers of 8-weight percent yttria stabilized zirconia (“8YSZ”), or 20-weight percent yttria stabilized zirconia (“20YSZ”). For pyrochlore containing thermal barrier coatings, an under layer of 8YSZ is required to form a bilayer 8YSZ/59 weight percent gadolinium stabilized zirconia (“8YSZ/59GZO”) coating, or a bilayer 8YSZ/30-50 weight percent yttria stabilized zirconia (“30-50 YSZ”) coating, or combinations thereof. The TBC adheres to the ceramic substrate outer surface. Optionally, a rough surface ceramic bond coat is applied over the CMC substrate by a known deposition process, further enhancing adhesion of the TBC layer to the ceramic substrate. In exemplary embodiments, the bond coat material is alumina or YAG to enable oxidation protection, in case of complete TBC spallation.

Although various embodiments that incorporate the invention have been shown and described in detail herein, others can readily devise many other varied embodiments that still incorporate the claimed invention. The invention is not limited in its application to the exemplary embodiment details of construction and the arrangement of components set forth in the description or illustrated in the drawings. The invention is capable of other embodiments and of being practiced or of being carried out in various ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted”, “connected”, “supported”, and “coupled” and variations thereof are used broadly and encompass direct and indirect mountings, connections, supports, and couplings. Further, “connected” and “coupled” are not restricted to physical, mechanical, or electrical connections or couplings.

1. A ceramic matrix composite (“CMC”) component for a combustion turbine engine, comprising:
a cured and solidified, fiber-reinforced, ceramic central substrate, having at least one substrate rib that is coupled to and bridges opposed first and second substrate sidewalls, and a first pattern of reinforcing fibers embedded within the substrate rib and substrate sidewalls, the first fiber pattern including:
respective first and second opposed planar sheets of reinforcement fabric, both of the first and second sheets respectively forming an elongated spine flanked on at least one lateral side by plural rows of integral strips, the plural rows of integral strips folded in staggered, alternate sequential rows of flat strips that are coplanar with the spine, and alternate sequential rows of pleated strips having pleats that project outwardly from the spine and the flat strips;
the spines and flat strips of the respective first and second sheets respectively embedded within the respective first and second substrate sidewalls, and staggered, commonly aligned and sequentially opposing rows of pleats of the respective first and second sheets embedded within the substrate rib and its opposing respective first or second sidewall; and
a cured and solidified, fiber-reinforced, ceramic outer wrapping having embedded therein a second fiber pattern of a third reinforcement fabric, the outer wrapping circumscribing the central substrate.

2. The component of claim 1, the pleated strips comprising box pleats having rectangular profiles, or accordion pleats having triangular profiles, or undulating pleats having sinusoidal profiles.

3. The component of claim 1, further comprising an axial reinforcing rib (“ARR”) embedded within the substrate rib of the central substrate, abutting the respective pleated strips of the first and second reinforcement fabric sheets.

4. The component of claim 3, the axial reinforcing rib woven between alternating and aligned respective pleats of the first and second reinforcement fabric sheets.

5. The component of claim 3, further comprising an axial reinforcing rib bridging a substrate rib at each location where respective projecting pleats of the first and second reinforcement fabric sheets cross each other.

6. The component of claim 1, the respective pleated strips of the first and second reinforcement fabric sheets affixed to its opposed fabric sheet along their respective abutting surfaces.

7. The component of claim 1, the respective pleated strips of the first, and second reinforcement fabric sheets slidable relative to each other and/or the outer wrapping along their respective abutting surfaces.

8. The component of claim 1, further comprising a cured and solidified, fiber-reinforced, ceramic inner wrapping circumscribed by the central substrate.

9. The component of claim 1, comprising a rotating turbine blade or stationary vane, the central substrate and outer wrapping forming an airfoil portion of the blade or vane, with respective spines of the first and second reinforcement fabric sheets aligned along an axis from root to tip of the blade or vane, the central substrate first and second sidewalls; and the outer wrapping forming a sidewall of the airfoil.

10. The component of claim 1, further comprising a thermally sprayed, vapor deposited, or solution/suspension plasma sprayed thermal barrier coat (“TBC”) over and coupled to the outer wrapping.

11. A method for manufacturing a ceramic matrix composite (“CMC”) component for a combustion turbine engine, comprising:
laying-up a first pattern of ceramic fibers, to fabricate a cured and solidified, fiber-reinforced, ceramic central substrate, having at least one substrate rib that is coupled to and bridges opposed first and second substrate sidewalls, the laid-up, first pattern of reinforcing fibers to be embedded within the substrate rib and substrate sidewalls, the first fiber pattern laid-up by:
providing first and second reinforcement fabric sheets;
lancing the respective first and second reinforcement fabric sheets to form an elongated spine flanked on at least one lateral side by plural rows of opposed and integral strips;
impregnating the first and second reinforcement sheets with ceramic slurry, if those sheets were not pre-impregnated with ceramic material prior to their lay-up;
folding the plural rows of strips of each respective first and second, impregnated reinforcement fabric sheet, in staggered, alternate sequential rows of flat strips that are coplanar with the spine, and alternate sequential rows of pleated strips that project outwardly from the spine and the flat strips;
orienting the first and second reinforcement fabric sheets with their respective elongated spines in opposed and mutually spaced relationship, and their respective pleated strips staggered, projecting toward, and abutting a corresponding respective opposed fabric sheet, so that the pleated strips will span across the substrate rib between the first and second sheets, the spines and flat strips of the respective first and second sheets respectively to be embedded within the respective first and second substrate sidewalls, and staggered, commonly aligned and sequentially opposing rows of pleats of the respective first and second sheets to be embedded within the substrate rib and its opposing respective first or second sidewall; and
laying-up a cured and solidified, fiber-reinforced, ceramic outer wrapping, which circumscribes the central substrate, by impregnating a second fiber pattern of a third reinforcement fabric with ceramic slurry, if the third fabric was not pre-impregnated with ceramic material prior to its lay-up, and wrapping the impregnated, third reinforcement fabric about the CMC central substrate; and
curing all of the impregnated reinforcement fabric, forming a solidified, fiber-reinforced, ceramic central substrate and outer wrapping of the CMC component.

12. The method of claim 11, further comprising folding the pleated strips in box pleats having rectangular profiles, or accordion pleats having triangular profiles, or undulating pleats having sinusoidal profiles.

13. The method of claim 11, further comprising embedding an axial reinforcing rib (“ARR”) within the substrate rib of the CMC central substrate, abutting the respective pleated strips of the first and second reinforcement fabric sheets.

14. The method of claim 13, further comprising weaving the axial reinforcing rib between alternating and aligned respective pleats of the first and second reinforcement fabric sheets.

15. The method of claim 13, further comprising embedding an axial reinforcing rib in a substrate rib, bridging the substrate rib at each location where respective projecting pleats of the first and second reinforcement fabric sheets cross each other.

16. The method of claim 11, further comprising affixing the respective pleated strips of the first and second reinforcement fabric sheets to its opposed fabric sheet along their respective abutting surfaces.

17. The method of claim 11, further comprising maintaining the opposed pleated strips of the first and second reinforcement fabric sheets as slidable relative to its opposed fabric sheet and/or the outer wrapping along their respective abutting surfaces, when solidifying the CMC central substrate.

18. The method of claim 11, further comprising inserting and circumscribing a cured and solidified, fiber-reinforced, ceramic inner wrapping within the central substrate.

19. The method of claim 11, further comprising forming an airfoil portion of a rotating turbine blade or stationary vane component, by aligning spines of the first and second reinforcement fabric sheets along an axis from root to tip of the blade or vane; and forming a sidewall of the blade with the outer wrapping and the substrate first and second sidewalls.

20. The method of claim 11, further comprising applying a thermally sprayed, vapor deposited, or solution/suspension plasma sprayed thermal barrier coat (“TBC”) over and coupled to the outer wrapping.
